(19) United States
(12) Patent Application Publication
(10) Pub. No.: US 2010/0285211 A1
(43) Pub. Date: Nov. 11, 2010

(54) METHOD OF USING CODED MARKING PATTERNS IN UNDERGROUND FACILITIES LOCATE OPERATIONS

(75) Inventors: Steven Nielsen, North Palm Beach, FL (US); Curtis Chambers, Palm Beach Gardens, FL (US); Jeffrey Farr, Jupiter, FL (US)

Correspondence Address: WOLF GREENFIELD & SACKS, P.C., 600 ATLANTIC AVENUE, BOSTON, MA, 02210-2206, US

(73) Assignee: CertusView Technologies, LLC, Palm Beach Gardens, FL (US)

(21) Appl. No.: 12/764,164

(22) Filed: Apr. 21, 2010

Related U.S. Application Data
(60) Provisional application No. 61/176,589, filed on May 8, 2009.

(51) Int. Cl. B05D 5/00

(52) U.S. Cl. 427/136

(57) ABSTRACT

Methods of using coded marking patterns in underground facilities locate operations are disclosed. Coded marking patterns may be dispensed, for example, on the surface of the ground to indicate types of facilities and any other useful information about the facilities. In one embodiment, coded marking patterns are provided that include a combination of marking material color to indicate types of facilities and unique marking patterns to indicate any other information about the facilities that may be beneficial to, for example, excavators and/or any other interested parties, such as facility owners. In another embodiment, color-agnostic coded marking patterns include unique marking patterns that may be dispensed using any color for indicating the types of facilities.

### CROSS-REFERENCE TO RELATED APPLICATION

This application claims a priority benefit, under 35 U.S.C. §119(e), to U.S. Provisional Application Ser. No. 61/176,589, filed May 8, 2009 under Attorney Docket No. D0687.70036US00, entitled “Method of Using Coded Marking Patterns in Underground Facilities Locate Operations,” which application is hereby incorporated herein by reference in its entirety.

### BACKGROUND

In the construction industry, the process of locating and marking underground facilities is required prior to any excavation activity. In this process, locate operations are generally performed at the request of excavators via a job ticket. A locate technician may use a locate receiver device and a marking device in order to perform a locate operation. A locate receiver device is an instrument for detecting facilities that are concealed in some manner, such as cables and pipes that are located underground. A locate receiver device detects electromagnetic fields that are emitted from a facility. A signal, or lack thereof, detected by the locate receiver device indicates the presence or absence of a facility. Once the presence or absence of a facility is detected, a marking material is dispensed on, for example, the surface of the ground at the location of the facility in order to communicate the presence or absence of a facility or facilities to an excavator. Marking material may be any material, substance, compound, and/or element which may be used separately or in combination to mark, signify, and/or indicate the presence or absence of a facility. Examples of marking materials may include, but are not limited to, paint, chalk, dye, and/or marking powder. Marking devices, such as paint marking wands and/or paint marking wheels, are used for dispensing marking materials onto surfaces, such as onto the surface of the ground.

Standards have been developed by which the color of the marking material is used to indicate the type of facility. For example, according to the American Public Works Association (APWA) Uniform Color Codes for temporary marking of underground facilities, red marking material indicates electric power lines; yellow marking material indicates gas lines; orange marking material indicates communication lines, such as, but not limited to, cable TV lines and fiber-optic communication lines; blue marking material indicates water lines; green marking material indicates sewer lines; and so on. Therefore, the color of the marking material that is dispensed, for example, on the surface of the ground may be used to communicate to the excavator the type of facility that is present underground.

However, while information about the types of facilities present may be conveyed to excavators by the marking material color, it may be beneficial for excavators (or other interested parties) to have awareness of other attributes of the underground facility. For example, while yellow marking material indicates gas lines, it may be beneficial for the excavator to know whether the gas line present is a high-pressure or low-pressure gas line in order to fully understand the risk of excavation and any precautionary measures that may be needed. Similarly, while orange marking material indicates communication lines, it may be beneficial for the excavator to know whether the communication line present is a high-profile (e.g., large fiber-optic bundle) or low-profile (e.g., single line drop to a residence) communication line, again, in order to fully understand the risk of excavation.

Therefore, because communication mechanisms between locate companies and excavators are limited, it may be beneficial to develop improved marking practices that are not limited to conveying the types of facilities only and, in particular, are able to convey to excavators (or other interested parties) additional information about the facilities that have been located.

### SUMMARY

According to a first aspect of the invention, a method is provided for marking the presence or absence of an underground facility in a dig area using a marking device that holds a marking dispenser. The method comprises: dispensing, with the marking device, marking material to form on the ground a first marking pattern that indicates a location and a type of the underground facility; and dispensing, with the marking device, marking material to form on the ground a second marking pattern that is representative of information in addition to the location and type of the underground facility.

According to embodiments of the invention, the first marking pattern includes a plurality of first marks and the second marking pattern includes one or more second marks.

According to embodiments of the invention, the first marks of the first marking pattern are dispensed along a path of the underground facility.

According to embodiments of the invention, the second marks of the second marking pattern are located in gaps between the first marks of the first marking pattern.

According to embodiments of the invention, the second marking pattern comprises at least one coded mark.

According to embodiments of the invention, the second marking pattern indicates an importance of the underground facility.

According to embodiments of the invention, the second marking pattern indicates a class of the underground facility.

According to embodiments of the invention, the second marking pattern indicates an owner of the underground facility.

According to embodiments of the invention, the second marking pattern indicates a locate company that dispensed the first and second marking patterns.

According to embodiments of the invention, the second marking pattern comprises a header with respect to the first marking pattern.

According to embodiments of the invention, the header is delineated by header marks.

According to embodiments of the invention, dispensing the second marking pattern includes dispensing a coded pattern of dots and dashes.

According to embodiments of the invention, dispensing the second marking pattern includes dispensing a coded pattern of dashes.

According to embodiments of the invention, dispensing the second marking pattern includes dispensing one or more characters.

According to embodiments of the invention, dispensing second marking pattern includes dispensing one or more symbols.

According to embodiments of the invention, the first marking pattern comprises a plurality of first marks separated by gaps and wherein the second marking pattern comprises second marks in the gaps between the first marks of the first marking pattern.

According to embodiments of the invention, the second marking pattern is located at or near an end of the first marking pattern.

According to embodiments of the invention, the second marking pattern is located at or near a middle of the first marking pattern.

According to embodiments of the invention, the second marking pattern includes marks of a single color.

According to embodiments of the invention, the first marking pattern and the second marking pattern include marks of the same color.

According to embodiments of the invention, dispensing marking material comprises dispensing marking paint.

According to embodiments of the invention, forming the first marking pattern and forming the second marking pattern includes moving the marking device with respect to the ground as the marking material is dispensed on the ground.

According to a second aspect of the invention, a method is provided for marking the presence or absence of an underground facility in a dig area using a marking device that holds a marking dispenser. The method comprises: dispensing, with the marking device, marking material to form a marking pattern that indicates a location and a type of the underground facility without relying on the color of the marking pattern to indicate the type of the underground facility.

According to embodiments of the invention, the marking pattern includes a coded pattern of marks to indicate the type of the underground facility.

According to embodiments of the invention, the marking pattern includes marks of a single color.

According to embodiments of the invention, the marking pattern includes a coded pattern of dots and dashes to indicate the type of the underground facility.

According to embodiments of the invention, the marks of the marking pattern are dispensed along a path of the underground facility.

According to embodiments of the invention, the method further comprises dispensing, with the marking device, marking material to form a header at one end of the marking pattern, the header representative of information in addition to the location and type of the underground facility.

According to embodiments of the invention, the header is delineated by header marks.

According to embodiments of the invention, the header indicates the importance of the underground facility.

According to embodiments of the invention, the header indicates a class of the underground facility.

According to embodiments of the invention, the header indicates an owner of the underground facility.

According to embodiments of the invention, the header indicates the locate company that dispensed the marking pattern.

According to embodiments of the invention, the method further comprises dispensing, with the marking device, marking material to form a second marking pattern that is representative of information in addition to the location and type of the underground facility.

According to embodiments of the invention, the second marking pattern is formed at one end of the first marking pattern.

According to embodiments of the invention, forming the marking pattern includes moving the marking device with respect to the ground as the marking material is dispensed on the ground.

### BRIEF DESCRIPTION OF THE DRAWINGS

The present disclosure, both as to its organization and manner of operation, together with further objectives and advantages, may be best understood by reference to the following description, taken in connection with the accompanying drawings as set forth below:

FIG. 1 is a perspective view of a conventional marking pattern being dispensed for indicating underground facilities;

FIG. 2 is a perspective view of an example of a coded marking pattern being dispensed for indicating underground facilities and other information, according to embodiments of the invention;

FIG. 3 is a top view of embodiments of coded marking patterns for indicating underground facilities and other information;

FIG. 4 is a top view of embodiments of coded marking patterns for indicating underground facilities and other information;

FIG. 5 is a top view of embodiments of color-agnostic coded marking patterns for indicating underground facilities;

FIG. 6 is a top view of embodiments of coded marking patterns for indicating underground facilities using alphanumeric characters;

FIG. 7 is a top view of embodiments of coded marking patterns for indicating underground facilities using geometric symbols; and

FIGS. 8A and 8B are top views of embodiments of color-agnostic coded marking patterns that include “header” information.

### DETAILED DESCRIPTION

Embodiments of the present invention relate generally to methods of using coded marking patterns in underground facilities locate operations and, in particular, coded marking patterns that may be dispensed, for example, on the surface of the ground to indicate types of facilities and any other useful information about the facilities. For example, in one embodiment, coded marking patterns include a combination of marking material color to indicate types of facilities and unique marking patterns to indicate other information about the facilities that may be beneficial to, for example, excavators and/or any other interested parties, such as facility owners. In another embodiment, color-agnostic coded marking patterns include unique marking patterns that may be dispensed using any color for indicating the types of facilities.

An aspect of the coded marking patterns of the present invention is that they provide a mechanism for readily communicating information about underground facilities to interested parties, such as to excavators and/or facilities owners. A mechanism for communicating such information does not otherwise exist in current processes for supporting locate operations.

Current marking practices with respect to locate operations may include dispensing a conventional marking pattern using a marking device, where the color of marking material correlates to a certain facility type. Further, the same standard marking pattern may be used for marking any type of facility. The location of the facility is indicated by the location of the mark.

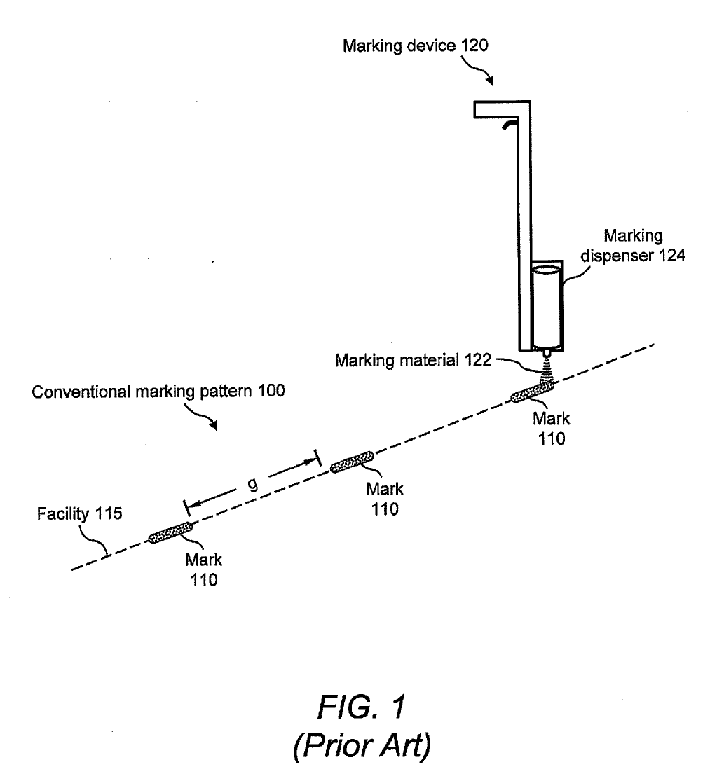

FIG. 1 is a perspective view of an example of a conventional non-coded marking pattern being dispensed for indicating underground facilities. FIG. 1 shows a conventional marking pattern 100 that is formed by a line or path of marks 110. In this example, a plurality of marks 110 is dispensed along the path of a facility 115 by a marking device 120. Marks 110 are the result of dispensing a marking material 122 from a marking dispenser 124 installed in marking device 120. Each mark of a standard marking pattern, such as each mark 110 of conventional marking pattern 100, may be, for example, about 12 inches to 18 inches long. Further, the gap (g) between marks 110 may be, for example, about 4 feet.

Additionally, the color of marking material 122 for forming marks 110 depends on the type of facility being marked. Table 1 shows an example of the correlation of marking material color to the type of facility to be marked.

TABLE 1
Correlation of marking material color to facility type

| Marking | |
|---|---|
| material | |
| color | Facility Type |
| Pink | Temporary survey markings |
| Red | Electric power lines, cables or conduits, and lighting cables |
| Yellow | Gas, oil, steam, petroleum, or other hazardous liquid or |
| | gaseous materials |
| Orange | Communications, cable TV, alarm or signal lines, cables, |
| | or conduits |
| Blue | Water, irrigation, and slurry lines |
| Purple | Reclaimed water, irrigation and slurry lines |
| Green | Sewers, storm sewer facilities, or other drain lines |

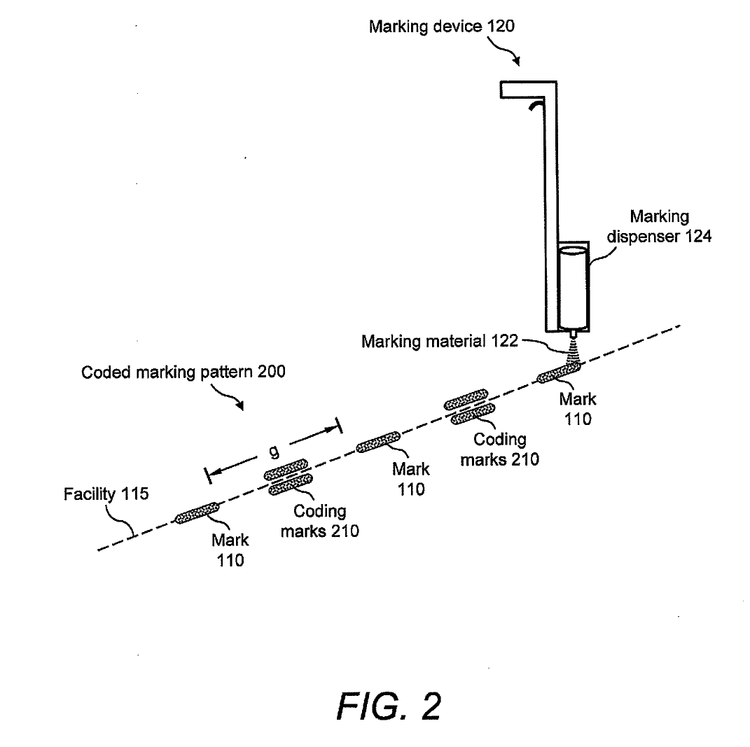

Referring again to FIG. 1, the color of the conventional marking pattern, such as conventional marking pattern 100, is the only mechanism by which any information about the facility may be conveyed. Further, the information conveyed by the color of the conventional marking pattern is limited to the type of facility. By contrast, FIGS. 2 through 8B show examples of coded marking patterns of the present invention for not only indicating the types of facilities, but also for indicating any other useful information about the facilities.

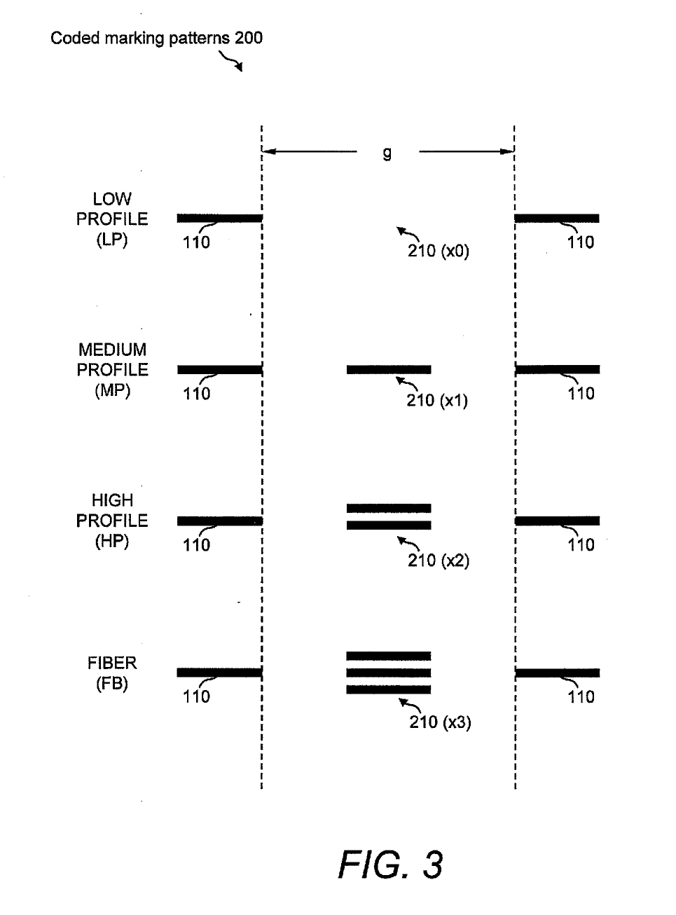

FIG. 2 is a perspective view of an example of a coded marking pattern 200 being dispensed for indicating underground facilities and other information. For example, coded marking pattern 200 may include marks 110, which may be the marks of any standard marking pattern. In the gaps (g) between marks 110, coded marking pattern 200 also includes one or more coding marks 210. The color of coded marking pattern 200 may indicate the type of facility, according, for example, to Table 1. In addition, specific arrangements of coding marks 210 located in the gaps (g) between marks 110 may have specified meanings in order to convey other information about the facility that has been located. More details of examples of coding marks and their meanings are described with reference to FIG. 3.

Marking device 120 may be any marking device that is capable of dispensing marking material to form a coded marking pattern on the ground. Marking material may be dispensed onto the ground using marking devices, such as marking wands, applicators and/or wheels. For example, marking device 120 may be the marking device that is described in U.S. patent application Ser. No. 11/696,606, filed Apr. 4, 2007, and published Oct. 9, 2008, as Publication No. 2008/0245299, entitled “Marking System and Method” and U.S. patent application Ser. No. 11/685,602, filed Mar. 13, 2007, and published Sep. 19, 2008 as Publication No. 2008/0228294, entitled “Marking System and Method with Location and/or Time Tracking”, both of which are incorporated herein by reference in their entirety. In other embodiments, a coded marking pattern may be dispensed by a conventional marking wand including a marking dispenser and a manual actuator. Any suitable marking device may be utilized to form coded marking patterns, embodiments of which are disclosed herein.

FIG. 3 is a top view of examples of types of coded marking patterns 200 for indicating underground facilities and other information. In a first type of a coded marking pattern 200, no coding marks 210 in the gaps (g) between marks 110 may indicate a LOW PROFILE (LP) facility. This coding in combination with the marking color may indicate to the excavator that the risk or consequence of damage is low for the facility type indicated.

In a second type of a coded marking pattern 200, one coding mark 210 in the gaps (g) between marks 110 may indicate a MEDIUM PROFILE (MP) facility. This coding in combination with the marking color may indicate to the excavator that the risk or consequence of damage is moderate for the facility type indicated.

In a third type of a coded marking pattern 200, two coding marks 210 in the gaps (g) between marks 110 may indicate a HIGH PROFILE (HP) facility. This coding in combination with the marking color may indicate to the excavator that the risk or consequence of damage is high for the facility type indicated.

In a fourth type of a coded marking pattern 200, three coding marks 210 in the gaps (g) between marks 110 may indicate FIBER (FB) in connection with indicating fiber-optics communication lines. This coding in combination with the marking color may indicate to the excavator that the risk or consequence of damage is high for fiber-optics communication lines.

The present invention is not limited to the examples of coded marking patterns that are shown in FIG. 3. These patterns and meanings are exemplary only. Any types of coded markings and corresponding meanings are possible for forming coded marking patterns for use in locate operations.

Further to the example, Table 2 illustrates an example of the use of coded marking patterns 200 with respect to certain types of facilities and other attributes thereof.

TABLE 2
Example uses of coded marking patterns 200

| Facility type and other attributes | | Type of coded |
|---|---|---|
| thereof | Marking color | marking pattern 200 |
| Telephone line - drop | Orange | LP |
| Telephone line - fiber | Orange | FB |
| Telephone line - medium pair | Orange | MP |
| Telephone line - large pair | Orange | HP |
| Telephone line - conduit | Orange | FB |
| Cable TV line - drop | Orange | LP |
| Cable TV line - fiber | Orange | FB |
| Cable TV line - coax | Orange | MP |
| Cable TV line - large coax | Orange | HP |
| Cable TV line - conduit | Orange | FB |
| Gas line - service line | Yellow | LP |
| Gas line - main line | Yellow | MP |
| Gas line - pipeline | Yellow | HP |
| Electric power line - service line | Red | LP |
| Electric power line - secondary line | Red | MP |
| Electric power line - primary line | Red | HP |
| Electric power line - conduit line | Red | FB |
| Water line - lateral line | Blue | LP |
| Water line - main line | Blue | MP |
| Sewer line - lateral line | Green | LP |
| Sewer line - main line | Green | MP |

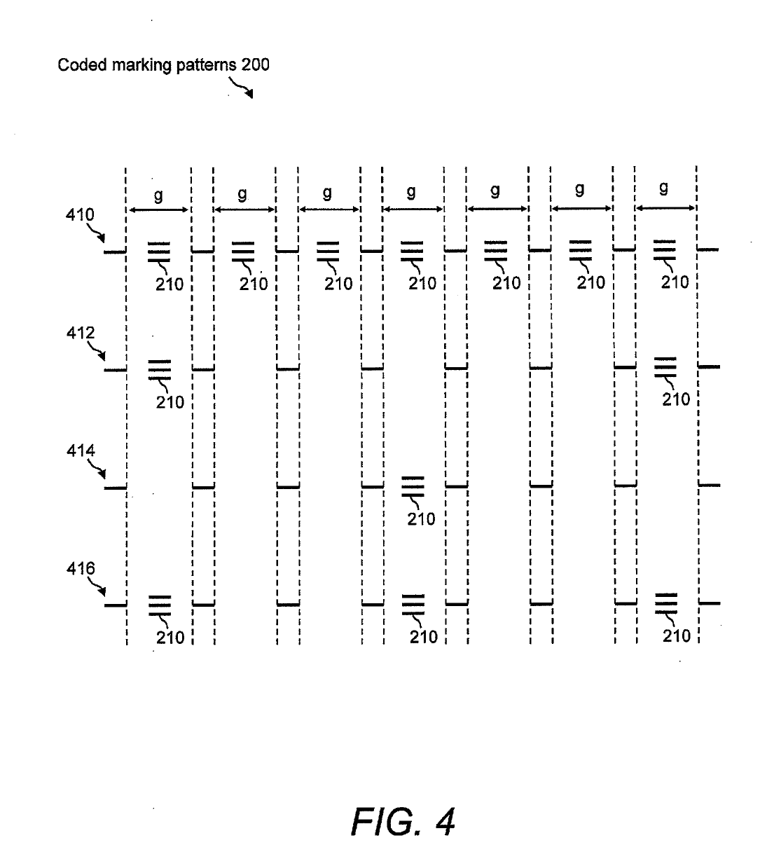

FIG. 4 is a top view of examples of coded marking patterns 200 for indicating underground facilities and other information. The coding marks 210 may be dispensed in one or more or all gaps (g) between marks 110 of coded marking patterns 200, for example, based on the discretion of the locate technician and/or based on set standards.

In a first example, FIG. 4 shows a coded marking pattern 410 wherein coding marks 210 are dispensed in all gaps (g) along the entire path of the coded marking pattern 200. In a second example, FIG. 4 shows a coded marking pattern 412 where coding marks 210 are dispensed in the gap (g) near each end only of the entire path of the coded marking pattern 200. In a third example, FIG. 4 shows a coded marking pattern 414 where coding marks 210 are dispensed in a gap (g) near the middle only of the entire path of the coded marking pattern 200. In a fourth example, FIG. 4 shows a coded marking pattern 416 where coding marks 210 are dispensed in a gap (g) near each end and near the middle of the entire path of the coded marking pattern 200.

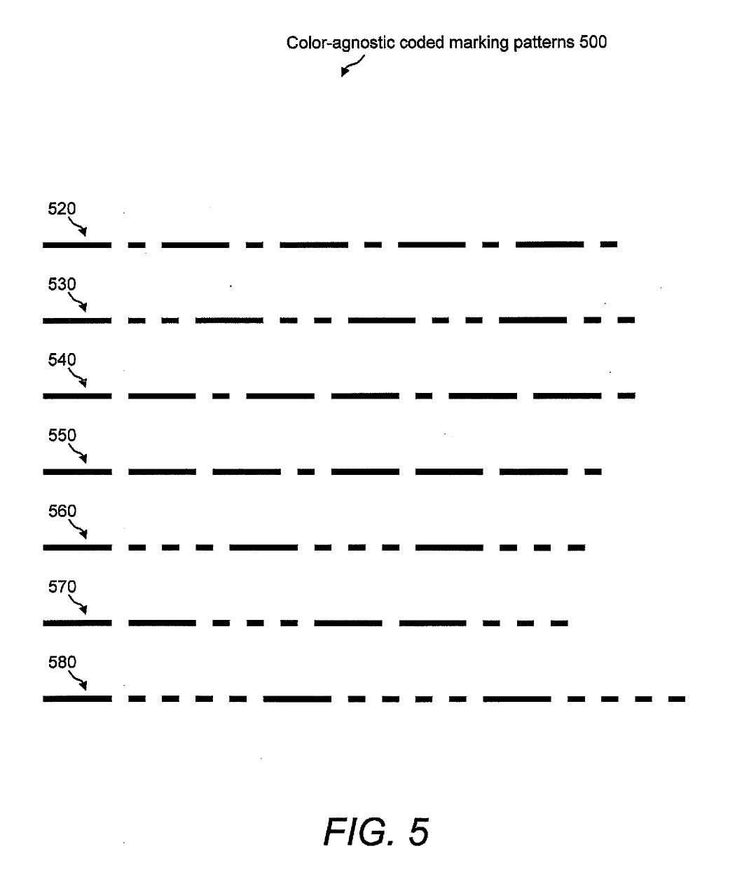

FIG. 5 is a top view of examples of color-agnostic coded marking patterns 500 for indicating underground facilities. In this embodiment, rather than using color to indicate the types of facilities, the color-agnostic coded marking patterns 500 use specific marking patterns that are dispensed in, for example, “Morse code” fashion in order to indicate the types of facilities. In this way, any color of marking material may be dispensed, while still indicating the types of facilities.

Referring again to FIG. 5 and to Table 3 below, examples of color-agnostic coded marking patterns 500 are illustrated.

TABLE 3
Examples of color-agnostic coded marking patterns 500

| Marking | | |
|---|---|---|
| Pattern | Pattern | Facility Type |
| 520 | Dash, Dot (repeat) | Temporary survey markings |
| 530 | Dash, Dot, Dot (repeat) | Electric power lines, cables or conduits, and |
| | | lighting cables |
| 540 | Dash, Dash, Dot (repeat) | Gas, oil, steam, petroleum, or other hazardous |
| | | liquid or gaseous materials |
| 550 | Dash, Dash, Dash, Dot (repeat) | Communications, cable TV, alarm or signal |
| | | lines, cables, or conduits |
| 560 | Dash, Dot, Dot, Dot (repeat) | Water, irrigation, and slurry lines |
| 570 | Dash, Dash, Dot, Dot, Dot (repeat) | Reclaimed water, irrigation and slurry lines |
| 580 | Dash, Dot, Dot, Dot, Dot (repeat) | Sewers, storm sewer facilities, or other drain |
| | | lines |

The present invention is not limited to the types of color-agnostic coded marking patterns that are shown in FIG. 5. These patterns and meanings are exemplary only. Any types of coded markings and corresponding meanings are possible with respect to forming color-agnostic coded marking patterns for use in locate operations.

While the exemplary coded marking patterns shown in FIGS. 2 through 5 utilize patterns of “dots” and/or “dashes,” those skilled in the art will recognize that other marks, characters, and/or symbols may be incorporated into coded marking patterns. For example, any combinations of dots, dashes, alphanumeric characters, geometric symbols (e.g., circles, rectangles, diamonds, triangles, etc), and so on may be used to form coded marking patterns for use in locate operations.

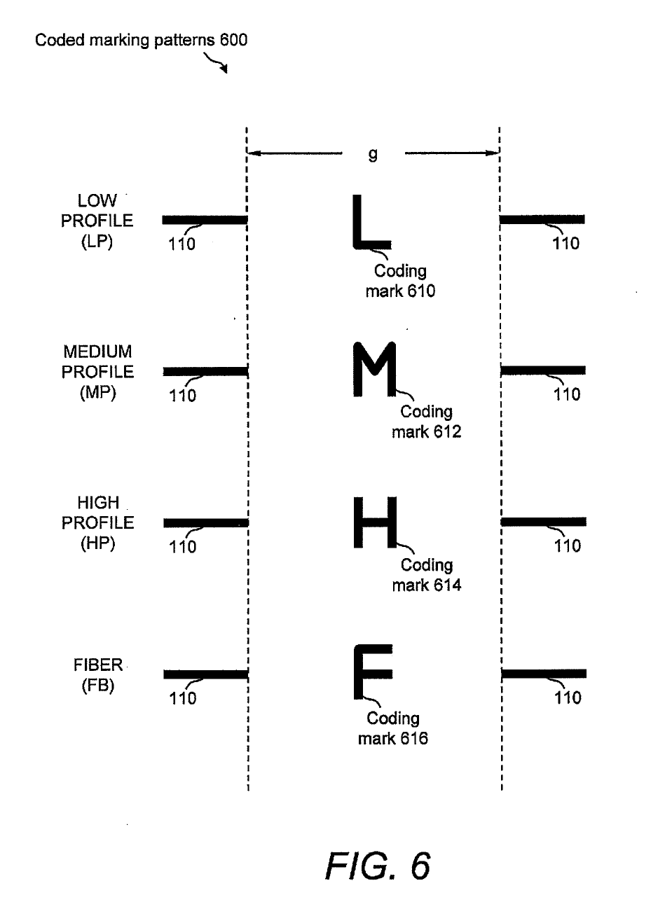

FIG. 6 is a top view of examples of coded marking patterns 600 for indicating underground facilities using alphanumeric characters. Coded marking patterns 600 have substantially the same meanings as coded marking patterns 200 of FIG. 3, except that coding marks 210 of FIG. 3 are replaced with characters. In a first type of a coded marking pattern 600, a coding mark 610 in the shape of the letter “L” is provided in the gaps (g) between marks 110 in order to indicate the LOW PROFILE (LP) facility. In a second type of a coded marking pattern 600, a coding mark 612 in the shape of the letter “M” is provided in the gaps (g) between marks 110 in order to indicate the MEDIUM PROFILE (MP) facility. In a third type of a coded marking pattern 600, a coding mark 614 in the shape of the letter “H” is provided in the gaps (g) between marks 110 in order to indicate the HIGH PROFILE (HP) facility. In a fourth type of a coded marking pattern 600, a coding mark 616 in the shape of the letter “F” is provided in the gaps (g) between marks 110 in order to indicate FIBER (FB) in connection with indicating fiber-optics communication lines.

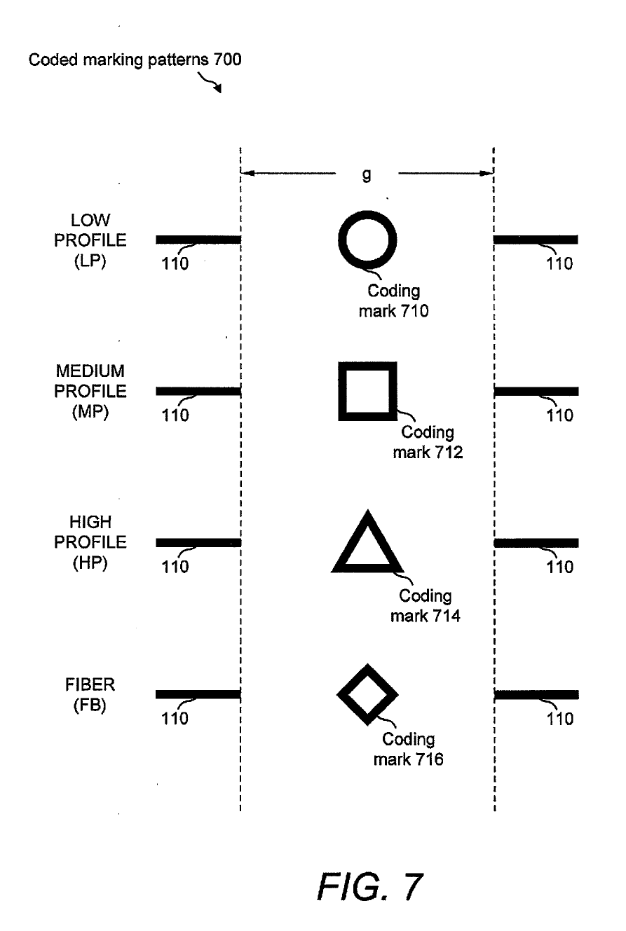

FIG. 7 is a top view of examples of coded marking patterns 700 for indicating underground facilities using geometric symbols. Coded marking patterns 700 have substantially the same meanings as coded marking patterns 200 of FIG. 3, except that coding marks 210 of FIG. 3 are replaced with symbols. In a first type of a coded marking pattern 700, a coding mark 710 in the shape of a circle is provided in the gaps (g) between marks 110 in order to indicate the LOW PROFILE (LP) facility. In a second type of a coded marking pattern 700, a coding mark 712 in the shape of a square is provided in the gaps (g) between marks 110 in order to indicate the MEDIUM PROFILE (MP) facility. In a third type of a coded marking pattern 700, a coding mark 714 in the shape of a triangle is provided in the gaps (g) between marks 110 in order to indicate the HIGH PROFILE (HP) facility. In a fourth type of a coded marking pattern 700, a coding mark 716 in the shape of a diamond is provided in the gaps (g) between marks 110 in order to indicate FIBER (FB) in connection with indicating fiber-optics communication lines.

Further, in addition to indicating information, such as the facility type and other attributes of the facility itself, coded marking patterns may be provided to indicate any useful information, such as, but not limited to, the facility owner name and/or the locate company name. In one example, codes may be provided to indicate certain facility owners and/or locate companies. Table 4 below shows example codes of various companies.

TABLE 4
Examples of codes for various companies

| Pattern | Company Name | Company Type |
|---|---|---|
| Dash, Dot | ABC Electric Co. | Facility owner |
| Dash, Dot, Dot | DEF Cable Inc. | Facility owner |
| Dash, Dash, Dot | JKL Gas Inc | Facility owner |
| Dash, Dot, Dot, Dot | MNP Locate Co. | Locate company |
| Dash, Dash, Dot, Dot, Dot | QRS Locate Co. | Locate company |
| Dash, Dot, Dot, Dot, Dot | XYZ Locate Co. | Locate company |

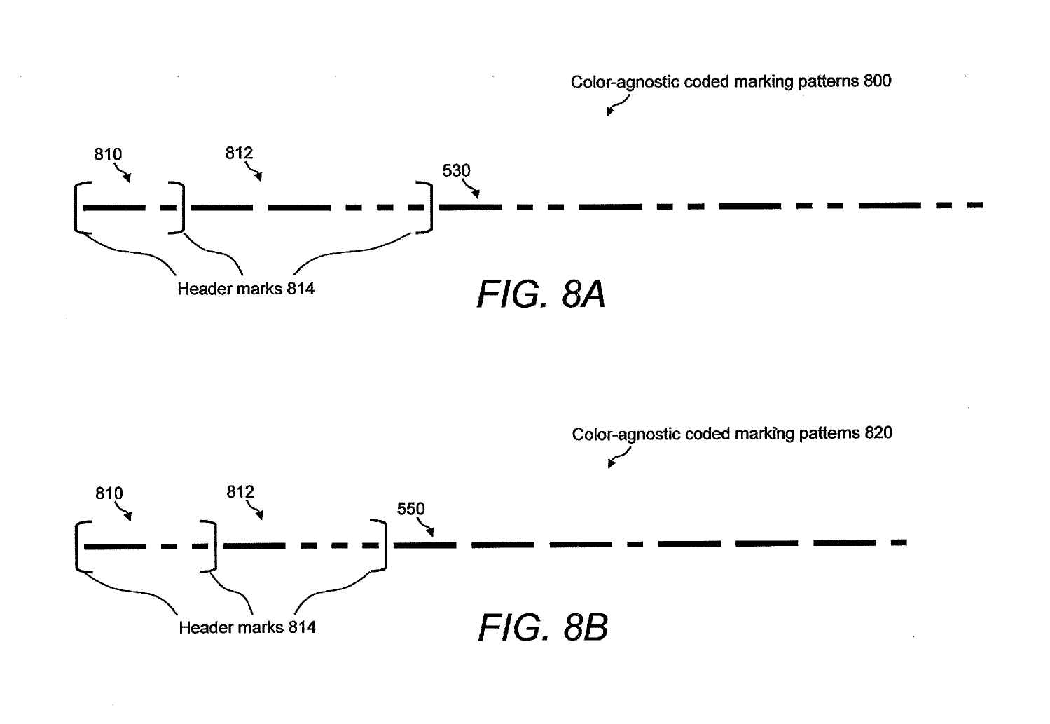

The information, such as shown in Table 4, may be encoded, for example, as “header” information with any coded marking pattern. In one example, the coded “header” information may indicate the name of the facility owner and/or the name of the locate company. FIGS. 8A and 8B are top views of examples of color-agnostic coded marking patterns 800 that include “header” information (such as information of Table 4).

FIG. 8A shows a color-agnostic coded marking pattern 800 that includes marking pattern 530 of FIG. 5 (i.e., an electric power line) in combination with coded “header” information that includes, for example, a section 810 and a section 812 bounded by header marks 814. In this example and referring to Table 4, section 810 includes the code for ABC Electric Co., which is the facility owner, and section 812 includes the code for QRS Locate Co., which is the locate company.

FIG. 8B shows a color-agnostic coded marking pattern 820 that includes marking pattern 550 of FIG. 5 (i.e., a communications line) in combination with coded “header” information that includes section 810 and section 812 bounded by header marks 814. In this example and referring to Table 4, section 810 includes the code for DEF Cable Inc., which is the facility owner, and section 812 includes the code for MNP Locate Co., which is the locate company.

In summary and referring to FIGS. 2 through 8B, the coded marking patterns of the present invention may be dispensed, for example, on the surface of the ground to indicate both the types of facilities and any other useful information about the facilities. For example, in one embodiment of the present invention, coded marking patterns, such as coded marking patterns 200, 600, and 700, include a combination of marking material color to indicate types of facilities and unique marking patterns to indicate any other information about the facilities that may be beneficial to any interested parties. In another embodiment of the present invention, color-agnostic coded marking patterns, such as color-agnostic coded marking patterns 500, include unique marking patterns that may be dispensed using any color for indicating the types of facilities. In yet another embodiment of the present invention, coded marking patterns, such as color-agnostic coded marking patterns 800, include coded “header” information.

The coded marking patterns 200, 600, 700 and 800 each include a first marking pattern which indicates facility type, such as by color (patterns 200, 600 and 700) or by coded marks (pattern 800), and a second marking pattern that is representative of other information. The coded marking patterns 500 include a single marking pattern that indicates facility type by coded marks.

Further, the coded marking patterns of the present invention, such as coded marking patterns 200, 600, and 700 and/or color-agnostic coded marking patterns 500 and 800, provide a mechanism for communicating information about underground facilities that have been located to any interested parties, which does not otherwise exist in current processes for supporting locate operations.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for marking the presence or absence of an underground facility in a dig area using a marking device that holds a marking dispenser, comprising:
dispensing, with the marking device, marking material to form on the ground a first marking pattern that indicates a location and a type of the underground facility; and
dispensing, with the marking device, marking material to form on the ground a second marking pattern that is representative of information in addition to the location and type of the underground facility.

2. A method as defined in claim 1, wherein the first marking pattern includes a plurality of first marks and the second marking pattern includes one or more second marks.

3. A method as defined in claim 2, wherein the first marks of the first marking pattern are dispensed along a path of the underground facility.

4. A method as defined in claim 3, wherein the second marks of the second marking pattern are located in gaps between the first marks of the first marking pattern.

5. A method as defined in claim 1, wherein the second marking pattern comprises at least one coded mark.

6. A method as defined in claim 1, wherein the second marking pattern indicates an importance of the underground facility, a class of the underground facility, an owner of the underground facility, and/or a locate company that dispensed the first and second marking patterns.

7. A method as defined in claim 1, wherein the second marking pattern comprises a header with respect to the first marking pattern.

8. A method as defined in claim 7, wherein the header is delineated by header marks.

9. A method as defined in claim 1, wherein dispensing the second marking pattern includes dispensing a coded pattern of dots and/or dashes.

10. A method as defined in claim 1, wherein dispensing the second marking pattern includes dispensing one or more characters.

11. A method as defined in claim 1, wherein dispensing second marking pattern includes dispensing one or more symbols.

12. A method as defined in claim 1, wherein the first marking pattern comprises a plurality of first marks separated by gaps and wherein the second marking pattern comprises second marks in the gaps between the first marks of the first marking pattern.

13. A method as defined in claim 1, wherein the second marking pattern is located at or near an end of the first marking pattern.

14. A method as defined in claim 1, wherein the second marking pattern is located at or near a middle of the first marking pattern.

15. A method as defined in claim 1, wherein forming the first marking pattern and forming the second marking pattern includes moving the marking device with respect to the ground as the marking material is dispensed on the ground.

16. A method for marking the presence or absence of an underground facility in a dig area using a marking device that holds a marking dispenser, comprising:
dispensing, with the marking device, marking material to form a marking pattern that indicates a location and a type of the underground facility without relying on the color of the marking pattern to indicate the type of the underground facility.

17. A method as defined in claim 16, further including dispensing, with the marking device, marking material to form a header at one end of the marking pattern, the header representative of information in addition to the location and type of the underground facility.

18. A method as defined in claim 17, wherein the header indicates the importance of the underground facility, a class of the underground facility, an owner of the underground facility, and/or the locate company that dispensed the marking pattern.

19. A method as defined in claim 16, further comprising dispensing, with the marking device, marking material to form a second marking pattern that is representative of information in addition to the location and type of the underground facility.

20. A method as defined in claim 19, wherein the second marking pattern is formed at one end of the first marking pattern.
